(19) United States
(12) Patent Application Publication
(10) Pub. No.: US 2018/0207678 A1
(43) Pub. Date: Jul. 26, 2018

(54) SEALANT SMEARING METHOD AND DISPLAY PANEL

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventor: Hongpeng LI, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/326,824

(22) PCT Filed: Feb. 4, 2016
(86) PCT No.: PCT/CN2016/073515

§ 371 Date: Jan. 17, 2017

(30) Foreign Application Priority Data
Sep. 25, 2015 (CN) 201510624356.7

(51) Int. Cl. B05D 1/26; G02F 1/1339; G02F 1/1341; G02F 1/13

(52) U.S. Cl. CPC B05D 1/26; G02F 1/1339; G02F 2001/13415; G02F 1/1303; G02F 1/1341

(57) ABSTRACT

A sealant smearing method and a display panel are provided. The sealant smearing method is used to perform sealant smearing for a display panel including multiple groups of sub-display panels. Each group of sub-display panels includes at least two columns of sub-display panels. The sealant smearing method, for each group of sub-display panels, includes smearing a first sealant at regions between any two adjacent columns of sub-display panels, and smearing a second sealant at left edges of a leftmost column of sub-display panels and at right edges of a rightmost column of sub-display panels. A width of the second sealant is larger than or equal to half of a width of the first sealant.

### CROSS-REFERENCE TO RELATED APPLICATIONS

The present application claims a priority to Chinese Patent Application No. 201510624356.7 filed on Sep. 25, 2015, the disclosure of which is incorporated in its entirety by reference herein.

### TECHNICAL FIELD

The present disclosure relates to the field of display technology, and in particular, to a sealant smearing method and a display panel.

### BACKGROUND

Currently, the pixels per inch (PPI) of product is higher and higher, and wirings of the array substrate of the thin-film transistor liquid crystal display (TFT-LCD) is denser and denser, and the aperture ratio of the TFT-LCD decreases gradually. For making visual effects such as brightness of high PPI products to be competitive with low PPI products, transmittance of the LCD needs to be enhanced. Therefore, manufacturers are developing negative liquid crystal products with high-transmittance.

Due to different diffusion directions of positive and negative liquid crystals, compared with positive liquid crystals, negative liquid crystals may have severer puncture phenomenon in manufacturing a panel, which results in a yield loss up to about 10%. Reference may be made to FIG. 1A and FIG. 1B. FIG. 1A is a schematic diagram of a puncturing direction of positive liquid crystals in the conventional technology, and FIG. 1B is a schematic diagram of a puncturing direction of negative liquid crystals in the conventional technology. As shown in FIG. 1A, the puncturing direction (i.e., an alignment direction or a diffusion direction) of positive liquid crystals is identical to a direction of a long edge of the panel, so it takes relatively long time for the positive liquid crystals to diffuse to two short edges of the panel. As shown in FIG. 1B, the puncturing direction (i.e., an alignment direction or a diffusion direction) of negative liquid crystals is identical to a direction of a short edge of the panel, so it takes relatively short time for the negative liquid crystals to diffuse to two long edges of the panel. Hence, compared with positive liquid crystals, negative liquid crystals may have severer puncture phenomenon.

Severe puncture phenomenon in manufacturing negative liquid crystal panel with high transmittance and low product yield are to be solved. There is no effective solution for solving these problems in the conventional technology.

### SUMMARY

The present disclosure intends to provide a technical solution which helps in reducing opportunities for puncture to occur in manufacturing high-transmittance negative liquid crystal panels, thereby improving the yield of negative liquid crystal products.

The present disclosure provides a sealant smearing method, which is used to perform sealant smearing for a display panel including a plurality of groups of sub-display panels. Each group of sub-display panels includes at least two columns of sub-display panels. The sealant smearing method, for each group of sub-display panels, includes: smearing a first sealant at regions between any two adjacent columns of sub-display panels, and smearing a second sealant at left edges of a leftmost column of sub-display panels and at right edges of a rightmost column of sub-display panels. A width of the second sealant is larger than or equal to ½ of a width of the first sealant.

Optionally, the width of the first sealant is identical to the width of the second sealant.

Optionally, the step of smearing the first sealant includes: controlling a first sealant-smearing device to smear the first sealant at the regions between any two adjacent columns of sub-display panels.

Optionally, the step of smearing the second sealant includes: controlling a second sealant-smearing device to smear the second sealant at the left edges of the leftmost column of sub-display panels and the right edges of the rightmost column of sub-display panels. The first sealant-smearing device is different from the second sealant-smearing device.

Optionally, the first sealant-smearing device is a Main seal smearing device and the second sealant-smearing device is a Dummy seal smearing device.

Optionally, the display panel includes at least three groups of sub-display panels arranged horizontally, and the step of smearing the first sealant includes: controlling a first sealant-smearing device to smear the first sealant at the regions between any two adjacent columns of sub-display panels in each group of sub-display panels. The first sealant-smearing device includes a first sealant-smearing element for smearing the first sealant at a leftmost group of sub-display panels, a third sealant-smearing element for smearing the first sealant at a rightmost group of sub-display panels, and a second sealant-smearing element for smearing the first sealant at each group of sub-display panels located between the leftmost group of sub-display panels and the rightmost group of sub-display panels.

Optionally, the step of smearing the second sealant includes: controlling the first sealant-smearing device to smear the second sealant at the left edges of the leftmost group of sub-display panels and the right edges of the rightmost group of sub-display panels, wherein the first sealant-smearing device comprises a fourth sealant-smearing element for smearing the second sealant at the left edges of the leftmost group of sub-display panels and a fifth sealant-smearing element for smearing the second sealant at the right edges of the rightmost group of sub-display panels, and the second sealant-smearing element is further configured to smear the second sealant at each group of sub-display panels between the leftmost group of sub-display panels and the rightmost group of sub-display panels.

Optionally, the first sealant-smearing device is a Main seal smearing device.

The present disclosure provides a display panel including a plurality of groups of sub-display panels. Each group of sub-display panels includes at least two columns of sub-display panels and further includes: a first sealant provided at regions between any two adjacent columns of sub-display panels, and a second sealant provided at left edges of a leftmost column of sub-display panels and at right edges of a rightmost column of sub-display panels. A width of the second sealant is equal to or larger than half of a width of the first sealant.

Optionally, the width of the first sealant is identical to the width of the second sealant.

Optionally, negative liquid crystals are contained in the display panel.

Compared with the conventional technology, in the sealant smearing method and display panel of the present disclosure, a whole large display panel is partitioned into multiple regions (i.e., multiple groups of sub-display panels), all sub-display panels in each region are processed similarly, and a sealant having twice larger width is smeared at edges of sub-display panels located at edges of each region. In this way, it is able to reduce opportunities for the dropped liquid crystals to puncture the sealant at the edges in substrate-alignment process of a negative liquid crystal product, thereby improving the yield of negative liquid crystal product.

### BRIEF DESCRIPTION OF THE DRAWINGS

FIG. 1A is a schematic diagram of a puncturing direction of positive liquid crystal in prior art;

FIG. 1B is a schematic diagram of a puncturing direction of negative liquid crystal in prior art;

FIG. 2 is a flow chart of a sealant smearing method according to at least one embodiment of the present disclosure;

FIG. 3 schematically illustrates a structure of single group of sub-display panels and sealant smearing procedure according to at least one embodiment of the present disclosure;

FIG. 4 schematically illustrates structures of multiple groups of sub-display panels and a sealant smearing procedure in accordance with a first approach according to at least one embodiment of the present disclosure; and

FIG. 5 schematically illustrates structures of multiple groups of sub-display panels and a sealant smearing procedure in accordance with a second approach according to at least one embodiment of the present disclosure.

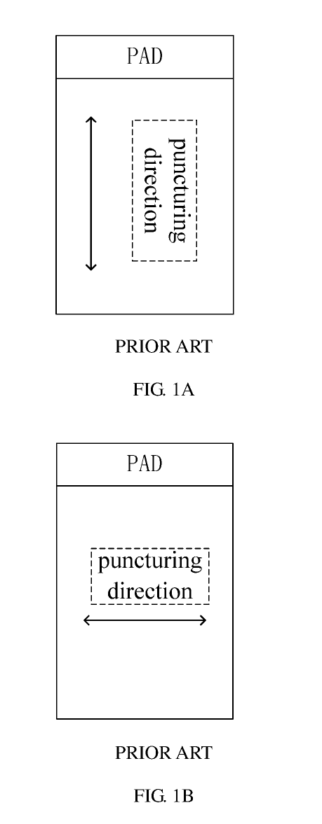

### DETAILED DESCRIPTION

Technical solutions according to embodiments of the present disclosure are fully and clearly described hereinafter in conjunction with drawings used in the embodiments. Apparently, the described embodiments are merely a part of rather than all embodiments of the present application. Any embodiment obtained by the ordinary skilled in the art based on the disclosed embodiments without creative efforts falls within the protection scope of the present disclosure.

Unless other definitions are given, technical terms or scientific terms used herein refer to normal meanings which can be understood by the ordinary skilled in the field to which the present disclosure relates. Terms such as “first” and “second” used in the specification and the list of claims of the present disclosure do not indicate any order, numbers or importance, and are merely used to distinguish different components. Similarly, terms such as “a” or “an” represent there exist at least one, rather than to limit the number. Terms such as “connected with” or “connected to” do not limit to physical or mechanical connections, and can include electrical connections which are either direct or indirect. Terms such as “on/above”, “under/below”, “left” and “right” are merely used to describe a relative position relationship; if the absolute position of one described object alters, the relative position relationship with respect to the described object alters correspondingly.

The present disclosure related to the manufacture of TFT-LCD, and in particular, relates to a sealant smearing method applied during manufacturing a liquid crystal panel based on one drop filling (ODF) process.

A conventional sealant smearing method for a negative liquid crystal product is to smear a sealant of an identical width at four edges of small panels to be obtained by cutting a large panel. Specifically, the sealant is initially smeared at a certain position on a periphery of one small panel and then gradually smeared along the whole periphery, so that sealant smearing for the small panel is accomplished; then, a small panel next to the sealed small panel is smeared with the sealant; and the above processes are repeated until all small panels are successively smeared with the sealant, that is, sealant smearing for the entire large panel is accomplished. The sealant may be subjected to slight collapse that is permissible by process requirement after smearing, and the sealant at an edge of one small panel may merge with the sealant at a corresponding edge of an adjacent small panel since a distance between the two adjacent small panels is tiny; hence, the sealant between any adjacent small panels may finally have a width twice as much as that of the originally smeared sealant. When dropping liquid crystals in a cell forming process, the liquid crystals may not puncture the wide sealant between two adjacent small panels.

For each small panel among two columns of small panels located near left and right edges of the large panel, only one time of sealant smearing is performed at an edge of the small panel near the left or right edge of the large panel, the width of the sealant smeared there is as much as that of the originally smeared sealant. Even subjected to collapse, the width of the sealant smeared at the edge of the small panel near the left or right edge of the large panel is still relatively small, and liquid crystals dropped into the small panel may easily puncture the sealant at the edge of the small panel.

In view of the above described phenomenon that negative liquid crystals easily puncture the sealant, if wider sealant is provided at the edge of each small panel among the two columns of small panels located near the left and right edges of the large panel, it may reduce opportunities for the puncture phenomenon to occur, thereby improving the yield of negative liquid crystal product.

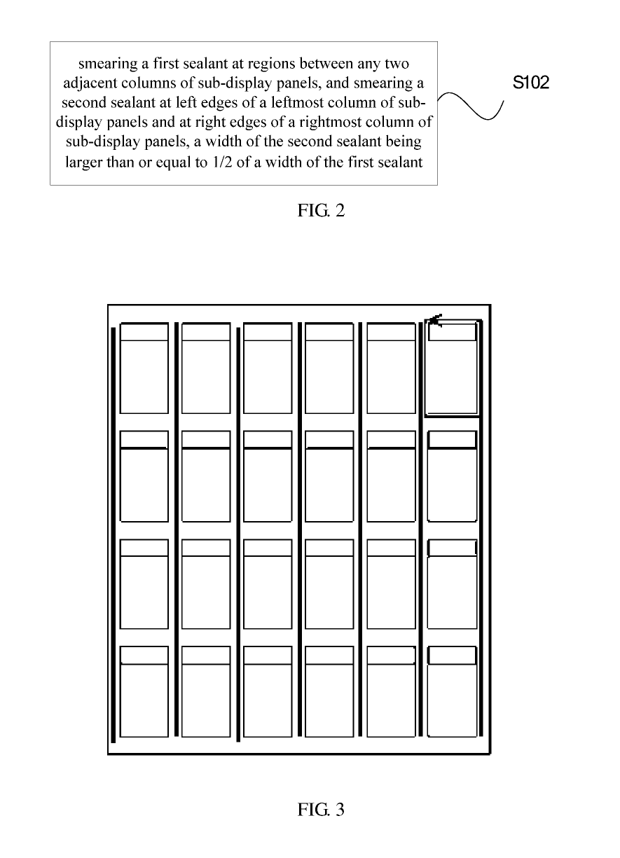

In accordance with the above concept, a sealant smearing method is provided according to some embodiments of the present disclosure. The sealant smearing method may be used to perform sealant smearing for a display panel including multiple groups of sub-display panels, where each group of sub-display panels includes at least two columns of sub-display panels. FIG. 2 is a flow chart of the sealant smearing method according to the embodiments of the present disclosure. As shown in FIG. 2, the sealant smearing method includes, for each group of sub-display panels, S102 as follows: smearing a first sealant at regions between any two adjacent columns of sub-display panels, and smearing a second sealant at left edges of a leftmost column of sub-display panels and at right edges of a rightmost column of sub-display panels. The width of the resultant second sealant is larger than or equal to ½ of the width of the resultant first sealant.

With such sealant smearing method, for a whole display panel having a relatively large size (which may also be referred to as a large panel before sealant smearing, i.e., the group of sub-display panels), when performing sealant smearing for the large display panel, a relatively wide sealant (e.g., the above second sealant) is smeared at the outer edge of each small display panel among two columns of small display panels (which may be referred to as small panels, i.e., the sub-display panels) located at edges of the large display panel. In this way, dropped liquid crystals may not easily puncture the sealant at the outer edge of each small display panel among the two columns of small panels located at edges of the large display panel.

Reference may be made to FIG. 3 for better understanding, which schematically illustrates a structure of single group of sub-display panels and sealant smearing procedure according to some embodiments of the present disclosure. Similar to the conventional sealant smearing method, the sealant smearing is started from a periphery of a certain small display panel of the whole large display panel. For improving the smearing efficiency, the sealant smearing is usually started from a corner of one small display panel located at a corner of the large display panel (Q-panel), and then the sealant is smeared along the periphery of the small display panel. As shown in FIG. 3, the sealant smearing is started from the top right corner of the small display panel located at the top right corner of the Q-panel. Firstly, the first sealant is smeared at vertical adjacent regions, i.e., regions between adjacent columns of sub-display panels, of the single group of sub-display panels shown in FIG. 3 (which includes 24 sub-display panels, i.e., 24 small panels), so as to prevent puncture phenomenon between adjacent sub-display panels (i.e., puncture phenomenon at an inner part of the Q-panel). The second sealant having a width no less than the conventional sealant needs to be smeared for an outer part of the Q-panel, i.e., for the two columns of sub-display panels located at the leftmost and rightmost edges of the Q-panel, so as to prevent puncture phenomenon at the outer part of the Q-panel.

According to embodiments of the present disclosure, firstly, adjacent sub-display panels are smeared using a sealant smearing process similar to the conventional sealant smearing process (i.e., smeared with the first sealant which equivalently has a width twice as much as that of the sealant smeared at the periphery of each sub-display panel in conventional sealant smearing process); then, outer edges of the two columns of sub-display panels located at leftmost and rightmost edges of the large display panel are smeared (i.e., smeared with the second sealant). Apparently, there is no limitation to sequence of smearing the first sealant and the second sealant, as long as the two kinds of sealants are smeared at corresponding regions.

Theoretically, as long as the second sealant has a width equal to or larger than that of the sealant conventionally smeared at the periphery of each sub-display panel, it may reduce opportunities for the puncture phenomenon to occur. The wider the second sealant, the less the opportunities; hence, the puncture phenomenon can be better prevented by increasing the width of the second sealant appropriately. The second sealant is not to be provided with a width as large as possible, and considering the complexity of the process, it is preferred to provide the first sealant and the second sealant with an identical width; in this case, the first sealant and the second sealant both have a width twice as much as a standard width of the sealant from a smearing device, and diffusion-induced stresses of the liquid crystals applied to the first sealant and the second sealant are substantially the same.

According to some embodiments, the first sealant and the second sealant may be smeared with the following two approaches.

With a first approach, a step of smearing the first sealant may include: controlling a first sealant-smearing device to smear the first sealant at regions between adjacent columns of sub-display panels. Correspondingly, a step of smearing the second sealant may include: controlling a second sealant-smearing device to smear the second sealant at the left edge and the right edge. Here, the first sealant-smearing device is different from the second sealant-smearing device.

In practical application, Main seal smearing device and Dummy seal smearing device are two most commonly-used sealant-smearing devices for sealant smearing. These two kinds of smearing devices do not have many essential differences, they are merely provided with different programs for controlling smearing areas: the Main seal smearing device is mainly used to smear a sealant at a display region while the Dummy seal smearing device is mainly used to smear a sealant for a glass sheet. In order to make minor modifications to conventional smearing method or process, according to some embodiments of the present disclosure, the Main seal smearing device serves as the first sealant-smearing device and the Dummy seal smearing device serves as the second sealant-smearing device; in this way, the process may not have increased complexity and the production efficiency of the products may not be adversely affected.

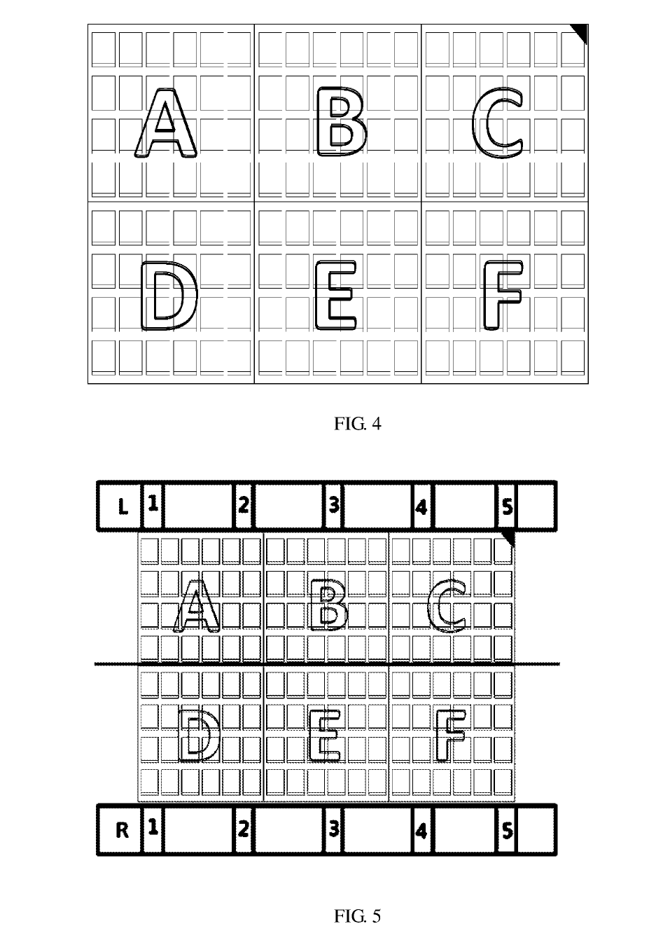

For better understanding, the first approach is detailed based on FIG. 4, which schematically illustrates structures of multiple groups of sub-display panels and a sealant smearing procedure in accordance with the first approach according to some embodiments of the present disclosure. In FIG. 4, there are six groups of sub-display panels represented by regions A to F. In the conventional smearing process, the Dummy seal smearing device and the Main seal smearing device are different devices, the Dummy seal smearing device needs about 70 s to smear the 1 sh Glass, which is far shorter than time spent by the Main seal smearing device (300 s); hence, in mass production, only two or three Dummy seal smearing devices are necessary for sealant smearing. Time used in smearing the 1 sh Glass in the first approach is about 20 s longer than that in the conventional smearing process, that is, time spent by the Dummy seal smearing device to smear the sealant is longer than that in the convention smearing process and the quantity of the Dummy seal smearing devices simultaneously used may be increased to, e.g., 4, which may hardly affect the overall production rhythm.

In case of a large number of sub-display panels, a second approach is provided, which better improves the production efficiency than the first approach. Hereinafter, it is described with an example that the display panel includes at least three horizontally-arranged groups of sub-display panels.

With the second approach, a step of smearing the first sealant may include: controlling a first sealant-smearing device to smear the first sealant at regions between adjacent columns of sub-display panels in each group. The first sealant-smearing device includes a first sealant-smearing element for smearing the first sealant at the leftmost group, a third sealant-smearing element for smearing the first sealant at the rightmost group, and a second sealant-smearing element for smearing the first sealant at each group located between the leftmost group and the rightmost group.

That is, the first sealant-smearing device is used to smear the first sealant for sub-display panels in various groups of sub-display panels located at three regions, and the smearing process is accomplished with three sealant-smearing elements. In this way, multiple sealant-smearing elements may cooperate to smear the first sealant, which improves the smearing efficiency.

Furthermore, a step of smearing the second sealant may include: controlling the first sealant-smearing device to smear the second sealant at left and right edges. The first sealant-smearing device includes a fourth sealant-smearing element for smearing the second sealant at the left edge of the leftmost group and a fifth sealant-smearing element for smearing the second sealant at the right edge of the rightmost group. The second sealant-smearing element is further used to smear the second sealant at each group between the leftmost group and the rightmost group.

Since the Main seal smearing device is mainly used to smear a sealant at the display region, in order to make minor modifications to the conventional smearing method or process, according to some embodiments of the present disclosure, the Main seal smearing device serves as the first sealant-smearing device to smear the first sealant and the second sealant. In this way, the process may not have increased complexity and the production efficiency of the products may not be adversely affected.

For better understanding, the second approach is detailed based on FIG. 5, which schematically illustrates structures of multiple groups of sub-display panels and a sealant smearing procedure in accordance with the second approach according to some embodiments of the present disclosure. In FIG. 5, there are six groups of sub-display panels represented by regions A to F. In the conventional smearing process, six Heads, i.e., six sealant-smearing elements are used for sealant smearing. The six Heads respectively correspond to six Q-panels, i.e., Head L1 corresponds to Q-panel A, Head L3 corresponds to Q-panel B, Head L5 corresponds to Q-panel C, Head R1 corresponds to Q-panel D, Head R3 corresponds to Q-panel E and Head R5 corresponds to Q-panel F. Heads L2, L4, R2 and R4 are not provided with any sealant. That is, in the conventional smearing process, the Heads are not fully used and the smearing efficiency is not high.

It should be noted that, before applying the second approach, the invoking way of the device needs to be adjusted and all Heads L1-L5 and R1-R5 are provided with sealant.

During sealant smearing for Q-panels with the second approach, sealant smearing for the left edge of the A-Qpanel and the right edge of the C-Qpanel are respectively performed by the Heads L1 and L5, sealant smearings for the A-Qpanel and the right edge of the A-Qpanel are performed by the Head L2, sealant smearings for the left edge of the B-Qpanel, the B-Qpanel and the right edge of the B-Qpanel are performed by the Head L3, and sealant smearings for the left edge of the C-Qpanel and the C-Qpanel are performed by the Head L4; sealant smearing for the left edge of the D-Qpanel and the right edge of the F-Qpanel are respectively performed by the Heads R1 and R5, sealant smearings for the D-Qpanel and the right edge of the D-Qpanel are performed by the Head R2, sealant smearings for the left edge of the E-Qpanel, the E-Qpanel and the right edge of the E-Qpanel are performed by the Head R3, and sealant smearings for the left edge of the F-Qpanel and the F-Qpanel are performed by the Head R4.

Compared with the conventional smearing process, the second approach merely leads to additional time for smearing the left and right edges, which is about 12 s-15 s; hence, the production efficiency is hardly affected.

In view of the above, with the second approach, the puncture phenomenon of negative liquid crystals is alleviated and the production efficiency is hardly affected by re-scheduling operations of respective Heads of the Main seal smearing device.

A display panel is provided in the present disclosure. The display panel includes multiple groups of sub-display panels. Each group of sub-display panels includes at least two columns of sub-display panels. Each group of sub-display panels includes: a first sealant provided at regions between adjacent columns of sub-display panels, and a second sealant provided at left edges of a leftmost column of sub-display panels and at right edges of a rightmost column of sub-display panels. The width of the second sealant is equal to or larger than half of a width of the first sealant.

According to some embodiments of the present disclosure, the first sealant may be arranged with a width identical to the second sealant, and advantages of such arrangement is described in the foregoing and is not repeated herein.

According to some embodiments of the present disclosure, liquid crystals contained in the display panel are negative liquid crystals.

Compared with conventional sealant smearing method, the sealant smearing method for TFT-LCD according to the embodiments of the present disclosure may effectively alleviate the puncture phenomenon in negative liquid crystal products, and time spent on sealant smearing is barely increased; hence, the production efficiency is slightly or even hardly affected.

The disclosed embodiments are optional embodiments of the present disclosure. It should be noted that, the ordinary skilled in the art can make various modifications and changes without departing from the principle and scope of the present disclosure, and all those modifications and changes fall within protection scope of the present disclosure.

1. A sealant smearing method, used to perform sealant smearing for a display panel comprising a plurality of groups of sub-display panels, wherein each group of sub-display panels comprises at least two columns of sub-display panels;
wherein the sealant smearing method, for each group of sub-display panels, comprises:
smearing a first sealant at regions between any two adjacent columns of sub-display panels, and smearing a second sealant at left edges of a leftmost column of sub-display panels and at right edges of a rightmost column of sub-display panels, a width of the second sealant being larger than or equal to half of a width of the first sealant.

2. The sealant smearing method according to claim 1, wherein the width of the first sealant is identical to the width of the second sealant.

3. The sealant smearing method according to claim 1, wherein the step of smearing the first sealant comprises:
controlling a first sealant-smearing device to smear the first sealant at the regions between any two adjacent columns of sub-display panels.

4. The sealant smearing method according to claim 3, wherein the step of smearing the second sealant comprises:
controlling a second sealant-smearing device to smear the second sealant at the left edges of the leftmost column of sub-display panels and the right edges of the rightmost column of sub-display panels;
wherein the first sealant-smearing device is different from the second sealant-smearing device.

5. The sealant smearing method according to claim 4, wherein the first sealant-smearing device is a Main seal smearing device and the second sealant-smearing device is a Dummy seal smearing device.

6. The sealant smearing method according to claim 1, wherein the display panel comprises at least three groups of sub-display panels arranged horizontally, and the step of smearing the first sealant comprises:
controlling a first sealant-smearing device to smear the first sealant at the regions between any two adjacent columns of sub-display panels in each group of sub-display panels, wherein the first sealant-smearing device comprises a first sealant-smearing element for smearing the first sealant at a leftmost group of sub-display panels, a third sealant-smearing element for smearing the first sealant at a rightmost group of sub-display panels, and a second sealant-smearing element for smearing the first sealant at each group of sub-display panels located between the leftmost group of sub-display panels and the rightmost group of sub-display panels.

7. The sealant smearing method according to claim 6, wherein the step of smearing the second sealant comprises:
controlling the first sealant-smearing device to smear the second sealant at the left edges of the leftmost group of sub-display panels and the right edges of the rightmost group of sub-display panels, wherein the first sealant-smearing device comprises a fourth sealant-smearing element for smearing the second sealant at the left edges of the leftmost group of sub-display panels and a fifth sealant-smearing element for smearing the second sealant at the right edges of the rightmost group of sub-display panels, and the second sealant-smearing element is further configured to smear the second sealant at each group of sub-display panels between the leftmost group of sub-display panels and the rightmost group of sub-display panels.

8. The sealant smearing method according to claim 7, wherein the first sealant-smearing device is a Main seal smearing device.

9. A display panel, comprising a plurality of groups of sub-display panels, wherein each group of sub-display panels comprises at least two columns of sub-display panels and further comprises:
a first sealant provided at regions between any two adjacent columns of sub-display panels, and
a second sealant provided at left edges of a leftmost column of sub-display panels and at right edges of a rightmost column of sub-display panels;
wherein a width of the second sealant is equal to or larger than half of a width of the first sealant.

10. The display panel according to claim 9, wherein the width of the first sealant is identical to the width of the second sealant.

11. The display panel according to claim 9, wherein negative liquid crystals are contained in the display panel.

12. The sealant smearing method according to claim 2, wherein the step of smearing the first sealant comprises:
controlling a first sealant-smearing device to smear the first sealant at the regions between any two adjacent columns of sub-display panels.

13. The sealant smearing method according to claim 2, wherein the display panel comprises at least three groups of sub-display panels arranged horizontally, and the step of smearing the first sealant comprises:
controlling a first sealant-smearing device to smear the first sealant at the regions between any two adjacent columns of sub-display panels in each group of sub-display panels, wherein the first sealant-smearing device comprises a first sealant-smearing element for smearing the first sealant at a leftmost group of sub-display panels, a third sealant-smearing element for smearing the first sealant at a rightmost group of sub-display panels, and a second sealant-smearing element for smearing the first sealant at each group of sub-display panels located between the leftmost group of sub-display panels and the rightmost group of sub-display panels.

14. The display panel according to claim 10, wherein negative liquid crystals are contained in the display panel.
